(19) United States
(12) Patent Application Publication
(10) Pub. No.: US 2025/0283282 A1
(43) Pub. Date: Sep. 11, 2025

(54) Roadway Milling Drums with Material Milling Tool Mounting and Conveying Components

(71) Applicant: LeRoy George Hagenbuch, Peoria Heights, IL (US)

(72) Inventor: LeRoy George Hagenbuch, Peoria Heights, IL (US)

(21) Appl. No.: 19/074,337

(22) Filed: Mar. 8, 2025

Related U.S. Application Data
(60) Provisional application No. 63/563,096, filed on Mar. 8, 2024.

(51) Int. Cl. E01C 23/088; B28D 1/18; E01C 23/12

(52) U.S. Cl. CPC E01C 23/088; B28D 1/188; E01C 23/127

(57) ABSTRACT

A milling drum for milling a working surface includes a drum body extending along an axis from a first end to a second end. The drum body includes an outer surface encircling the axis. The milling drum also includes helicoid flighting secured around the outer surface of the drum body. The helicoid flighting includes an inner side attached to the drum body and an outer periphery. A plurality of milling tool mounts are secured on the outer periphery of the helicoid flighting.

### CROSS REFERENCE TO RELATED APPLICATIONS

This application claims priority to U.S. Provisional Pat. App. No. 63/563,096 filed Mar. 8, 2024, which is hereby incorporated by reference herein in its entirety.

### FIELD

The present disclosure generally relates to a milling drum for a roadway milling machine.

### BACKGROUND

Since the beginning of civilization, the movement of man and goods has been critical to civilization's development. From the days of the Roman Empire with all roads leading to Rome, the canals and boats of England and America, and the railroads on several continents (in fact the railroad gauge in some places emulates the Roman chariot wheels) to finally the automobiles and trucks of the twentieth century the movement of man and goods has always been critical to man's progress. Automobiles and trucks, however, to be useful must have roads.

As the development of roads progressed first with plank roads, to gravel roads, to in recent times concrete roads and finally today often concrete roads with an asphalt overlay, or in certain European countries very thick asphalt roads (asphalt 300 mm or 12 inches thick). The maintenance of all roads, however, is critical to a roadway's usefulness. Concrete roads only have a projected useful life (often 25 years). To extend a roadway's useful life (particularly concrete roadways) maintenance of that roadway must occur along the way. A typical maintenance effort with concrete roadways is the application of one or more asphalt overlays. However, even concrete asphalt overlays can often require serious reconditioning. And such reconditioning often entails milling off/removal of some or all of the asphalt overlays and processing/reconstituting the milled asphalt cuttings into new reconditioned asphalt to again be used as an asphalt overlay.

In roadway reconditioning it may also be beneficial to remove some thickness of the concrete roadway. Roadway milling can also be wide-scale complete roadway removal in the rehabilitation of concrete pavements and airport runways as well as fine roadway milling improving pavement skid resistance.

Asphalt and concrete pavements can be cost-effectively removed with roadway milling machines. The range of applications extends from the complete removal of asphalt and concrete to the layer-by-layer removal and levelling of asphalt and concrete surfaces.

Further sometimes in roadway reconditioning removal of some or all of the base concrete roadway is needed. Such removal typically only occurs after all (if any) asphalt overlay previously applied has been milled/removed from the concrete roadway so the concrete roadway can then be torn up, removed and crushed with standard rock crushing equipment and recycled, which is something that is happening more and more with several sections of the current “interstate” highway system.

Asphalt and concrete roadways can be cost-effectively reconditioned with roadway milling machines. The range of roadway reconditioning applications extends from the complete removal of asphalt and concrete roadways to the layer-by-layer removal and levelling of asphalt and concrete roadway surfaces. And at the heart of this roadway reconditioning is the roadway milling drum.

The present inventor has recognized that improvements to milling machinery, in order to increase efficiency of the milling machinery, to increase the usable life of the components, or both, would be attractive to customers of such machinery.

### SUMMARY

Thus, the present disclosure provides a milling configured to remove hard surfaces, such as roadway surfaces, which uses milling tools mounted onto helicoid flighting.

In a first aspect, the disclosure provides a milling drum for milling a working surface, the milling drum comprising:
a drum body extending along an axis from a first end to a second end, the body including an outer surface encircling the axis;
helicoid flighting secured around the outer surface of the drum body, the helicoid flighting including an inner side attached to the drum body and an outer periphery; and
a plurality of milling tool mounts secured on the outer periphery of the helicoid flighting.

In another aspect, the disclosure provides a surface profiling machine comprising:
a vehicle propulsion system; and
a milling drum including:
   a drum body extending along an axis from a first end to a second end, the body including an outer surface encircling the axis;
   helicoid flighting secured around the outer surface of the drum body, the helicoid flighting including an inner side attached to the drum body and an outer periphery;
   a plurality of milling tool mounts secured on the outer periphery of the helicoid flighting; and
   a milling tool coupled to each milling tool mount.

In another aspect, the disclosure provides a method of milling a working surface, the method comprising:
positioning a milling drum against the working surface, the milling drum comprising:
   a drum body extending along an axis from a first end to a second end, the body including an outer surface encircling the axis,
   helicoid flighting secured around the outer surface of the drum body, the helicoid flighting including an inner side attached to the drum body and an outer periphery,
   a plurality of milling tool mounts secured on the outer periphery of the helicoid flighting, and
   a milling tool coupled to each milling tool mount; and
rotating the milling drum against the surface such the milling tools engage the surface and remove portions of the surface while the flighting conveys the removed portions of the surface in a predetermined direction.

These and other aspects of the disclosure will be evident to those of ordinary skill in the art from the following description.

### BRIEF DESCRIPTION OF THE DRAWINGS

The present disclosure is described in greater detail below based on the exemplary figures. The figures are not necessarily to scale and certain features and certain views of the figures may be exaggerated in scale or depicted in schematic form for clarity or conciseness. The disclosure is not limited to the exemplary embodiments. All features described and/or illustrated herein can be used alone or combined in different combinations in embodiments of the disclosure. Features and advantages of various embodiments of the disclosure will become apparent by reading the following detailed description with reference to the figures which illustrate the following:

FIG. 1 is a schematic side view of a roadway milling machine according to an embodiment of the disclosure;

FIG. 2 is a schematic perspective view of a milling drum according to an embodiment of the disclosure;

FIG. 3 is a schematic plan view of the milling drum of FIG. 2;

FIG. 4 is a schematic end view of the milling drum of FIG. 2;

FIG. 5 is a schematic perspective view of the milling drum of FIG. 2 with the milling tools removed for clarity;

FIG. 6 is a schematic perspective view of the milling drum of FIG. 2 with the milling tool mounts and milling tools removed for clarity;

FIG. 7 is a detailed side view of a cross-sectional view of a portion of the milling drum, including flighting, a milling tool mount, and a milling tool;

FIGS. 8A-8D illustrate forward movement of a rolling milling tool secured to the drum as the drum rotates.

### DETAILED DESCRIPTION

As set forth above, the present inventor has recognized that improvements to milling machinery, in order to increase efficiency of the milling machinery, to increase the usable life of the components, or both, would be attractive to customers of such machinery.

In one aspect, the disclosure provides a milling drum for milling a working surface, such as a roadway. The milling drum includes a drum body extending along an axis from a first end to a second end. The drum body includes an outer surface encircling the axis. Helicoid flighting is secured around the outer surface of the drum body, with an inner side of the flighting attached to the drum body and an outer periphery positioned away from the drum body. A plurality of milling tool mounts are secured on the outer periphery of the helicoid flighting, and milling tools are secured by the milling tool mounts.

In another aspect, the disclosure provides a milling machine having such a milling drum. Large roadway milling machines utilizing such milling drums often have weights approaching 45,000 kg or 100,000 pounds and can, in one pass, mill widths approaching 4.5 meters or 15 feet. These large roadway milling machines are powered with internal combustion motors approaching 750 kw or 1000 horsepower, and the drums may weight upwards of 8,000 pounds.

Large roadway milling machines generate a lot of cuttings, typically asphalt cuttings, though sometimes concrete chippings. For these milling machines to effectively operate these cuttings or chippings should be removed. This removal process may include moving the removed material to the lateral center of the milling drum and then onto the roadway milling machine discharge conveyor. The discharge conveyor may then load the removed material into trucks for transport to a collection point.

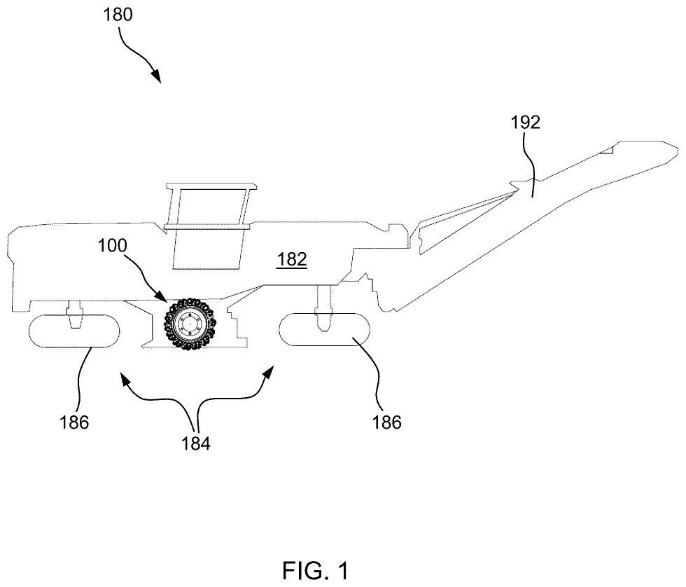

An example milling machine in accordance with the disclosure is shown in FIG. 1. The illustrated milling machine 180 includes a machine body 182 that is supported on a vehicle propulsion system 184 formed by track components 186. A milling drum 100 is provided as an integral part of milling machine 180 and is positioned underneath the machine body 182 toward the middle of the machine. The milling drum 100 is configured to rotate in order to remove layers of a surface that lies under machine body 182. For example, the milling drum 100 may rotate in a range of 90 to 140 rpm. The milling machine 180 also includes a conveyor 192 that is configured to transport the removed material away from the cut surface, such as to a transport vehicle.

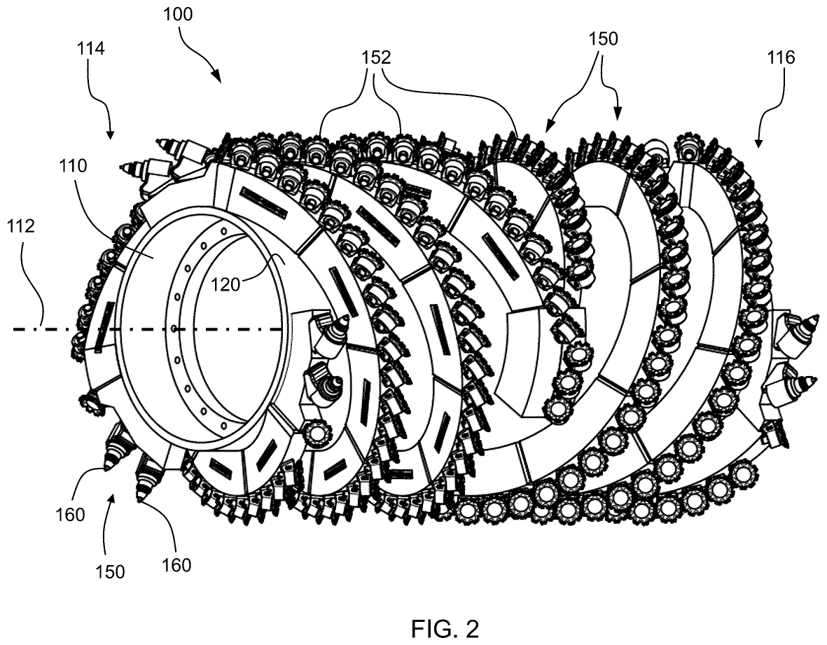

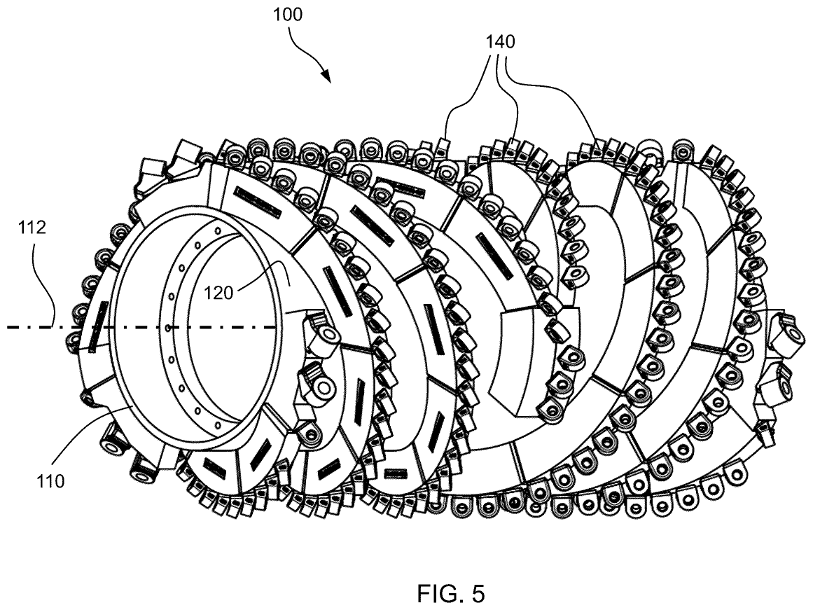

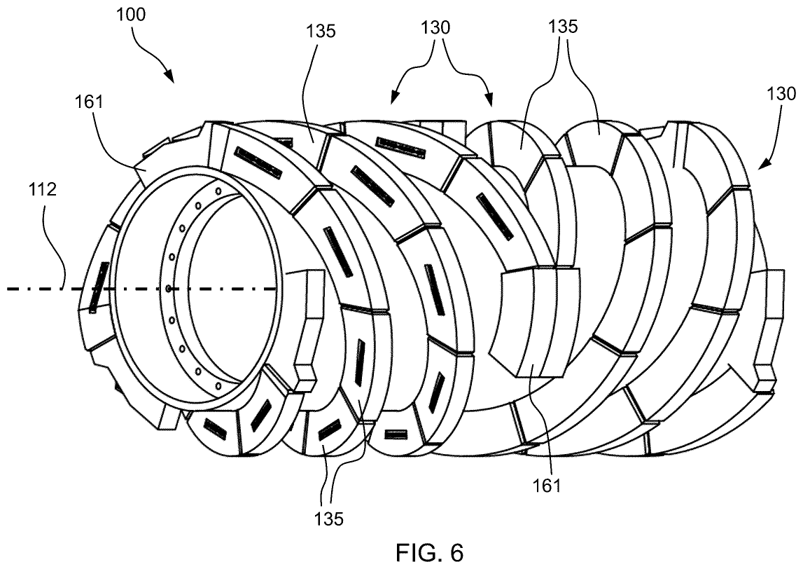

FIGS. 2 to 5 illustrate an embodiment of a milling drum according to the disclosure. The milling drum 100 includes a cylindrical drum body 110 extending along an axis 112 from a first end 114 to a second end 116. The drum body 110 includes a circumferential outer surface 120 that encircles the axis 112. Helicoid flighting 130 (see FIG. 6) is secured to the outer surface 120 of the drum body 110 and a plurality of milling tool mounts 140 (see FIG. 5) are secured to the outer periphery of the flighting 130. During operation, the milling drum 100 also includes milling tools 150 held in the milling tool mounts 140. That said, the term “milling drum,” as used in accordance with this disclosure, also includes drums that do not have milling tools inserted into the milling tool mounts. Such milling drums may be further assembled to include the milling tools prior to use.

As stated above, the flighting of the milling drum of the disclosure is secured to the outer surface of the cylindrical drum body. The term cylindrical drum body, as used herein, refers to a structure including a rounded outer surface that extends along an axis of the body. The shape of the outer surface can be substantially uniform along the length of the drum body, as in an ideal cylinder, or it can vary in shape along the length of the drum body.

The flighting 130 of the milling drum 100 of the disclosure interacts with the material being removed by the milling tools 150 by applying a pushing force against the material as the milling drum rotates. The helical shape of the flighting may impart a continuous lateral motion of the removed material as the rotating flighting guides the material along a controlled path. Depending on the pitch of the flighting, the material can be moved more quickly or slowly, with a lower pitch increasing the pressure and efficiency of the movement.

The flighting 130 also supports the milling tool mounts 140, and thereby governs, at least in part, the position of the milling tools 150. As shown in FIG. 6, which illustrates milling drum 100 without the milling tools or milling tool mounts, the flighting 130 may be formed by a plurality of flighting segments 135, though in other embodiments, the flighting may be formed in a single continuous helix.

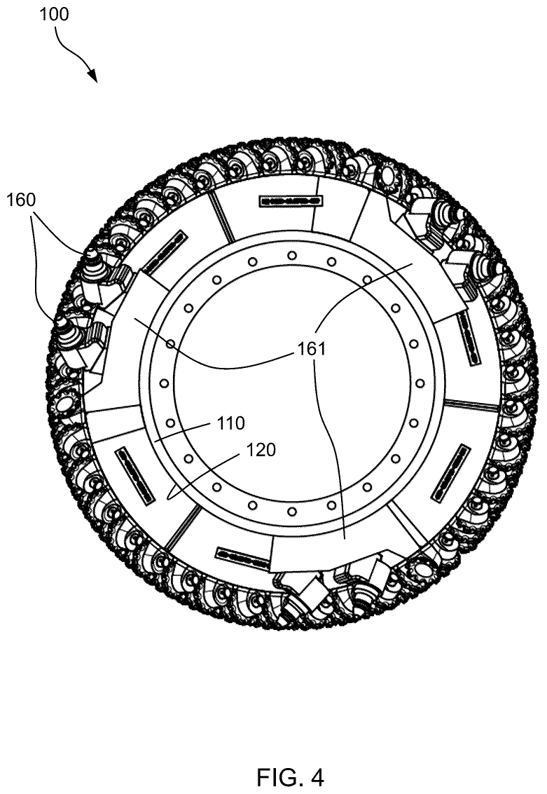

In embodiments of the disclosure, the milling tools may have different configurations. For example, in some embodiments, the milling tools may be configured as rolling milling tools, as explained in more detail below. In other embodiments, the milling tools may be configured as picks, such as carbide picks. Further, in some embodiments, the milling tools may include a combination of rolling milling tools and carbide picks. In the illustrated example shown in FIGS. 2-7, the milling tools 150 secured to the flighting segments 135 are all formed by rolling milling tools 152, while carbide picks 160 are secured to blocks 161 that form the helix starting points (see FIG. 4).

A milling drum in accordance with the disclosure may use a carefully arranged pattern of milling tools on the drum to achieve efficient milling performance. Securing the milling tool mounts 140, and associated milling tools 150, to the flighting or flighting segments 135 may offer several advantages in terms of fabrication, maintenance, and performance.

One benefit of securing the milling tool mounts 140 to the flighting segments 135 is the simplification of the manufacturing process. When milling tool mounts or standoffs are secured directly onto the drum body, each individual attachment must be precisely placed and secured, which can be time-consuming and labor-intensive. By contrast, if the milling tool mounts 140 are first arranged on the flighting segments 135, this process can be performed in a more controlled environment, potentially using automated equipment to ensure precision and consistency. Accordingly, in accordance with the disclosure, each flighting segment 135 supports multiple milling tool mounts 140.

Additionally, the flighting segments 135 can be designed to facilitate alignment. For example, the flighting segments 135 inherently follow the desired path for the milling tool mounts 140. Further, in some examples, the flighting segments 135 may include structural guides, such as pre-formed slots or recesses for the milling tool mounts 140, reducing the likelihood of placement errors. Once the milling tool mounts 140 are secured to a flighting segment 135, the entire assembly can be attached to the drum body 110 in a single step, greatly improving efficiency.

In some embodiments, each flighting segment 135 is formed in a single integral piece and supports a plurality of milling tool mounts 140, such as at least three milling tool mounts 140. For example, the flighting segments 135 may be formed as cast metal pieces.

In some embodiments, the flighting segments 135 may be secured to the drum body 110 by welding. For example, flighting segments can be secured to the drum by welding. For example, manual welding performed by a skilled welder using techniques like MIG, TIG, or stick welding may allow for precise or custom control of the weld. Alternatively, robotic welding may be used for greater consistency, speed, and repeatability, reducing human error and increasing efficiency. In some examples, the flighting segments may be secured to the drum body by laser welding, which may produce deep, narrow welds with minimal heat distortion. The choice of welding method depends on factors such as production volume, material properties, and cost considerations. Further still, in some embodiments, other attachment techniques may be employed.

Use of the flighting segments 135 can also significantly enhance the maintainability of the milling drum 100. In conventional systems where mounting standoffs are individually mounted, replacing worn or damaged milling tool mounts or standoffs requires removing and reattaching them one by one. Depending on the method of attachment, this could be a complex process, especially where the milling tool mounts or standoffs are welded or permanently bonded to the drum body.

With the flighting segments 135, a section of milling tools 150 can be replaced as a unit. For instance, an entire section of milling tools 150 arranged on a flighting segment 135 can be swapped out quickly, minimizing downtime. This approach is particularly advantageous where rapid servicing is necessary to maintain productivity.

Another advantage of the flighting of the disclosure is that it can provide a stronger and more reliable connection between the milling tool mounts and the drum body. When the milling tool mounts are secured to standoffs that are individually attached to the drum body, the attachment method is often limited by the material properties of the drum body itself. For instance, the curved surface of the drum body can make welding of each milling tool mount challenging, reducing the effectiveness of the attachment.

In contrast, the flighting can be designed with geometries that enhance the connection to the milling tool mount. For example, the flighting or flighting segment may be made from a material that is better suited for high-strength bonding, or it may incorporate reinforcement features such as interlocking tabs, dovetails, or additional fasteners that enhance the stability of the milling tools. This allows for more secure attachment methods that are not feasible with a connection between the mounting standoffs and drum body. On the other hand, because of the relatively large size of the flighting segment 135, the attachment of the flighting segment 135 to the drum body 110 may be less complicated.

In some embodiments, the flighting segments may extend around a portion of the circumference of the drum body in a range of 30 degrees to 180 degrees, for example around 45 degrees.

In some embodiments, the milling drum may include a group of flighting segments that each support the same configuration of milling tool mounts. As a result, the flighting of the drum may have a modular configuration, where the initial assembly of the milling drum includes securing a number of the same flighting segments with milling tool mounts to the drum body. Moreover, maintenance of such a modular construction allows a flighting segment to be replaced by any other having the same uniform construction.

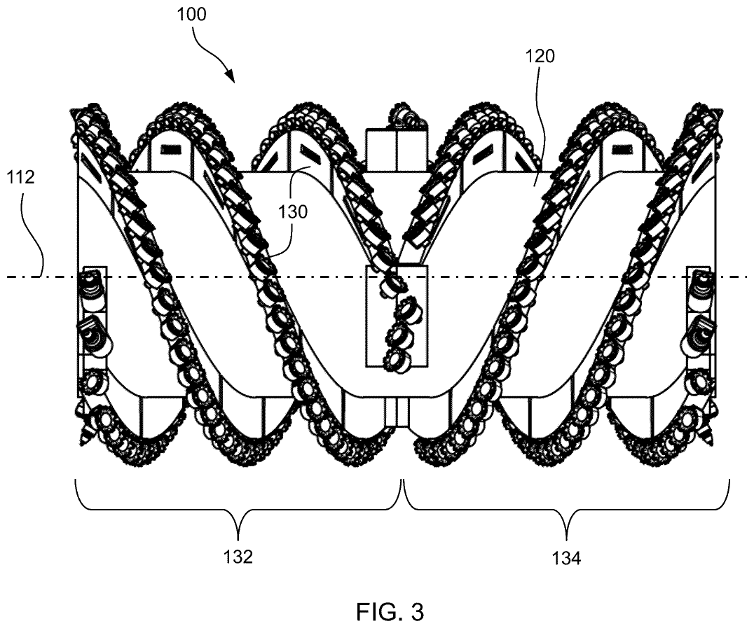

In some embodiments, the helicoid flighting includes a first section that winds around the drum body in a first direction, and a second section that winds around the drum body in a second direction. For instance, one section of flighting may include a left-hand direction while another has a right-hand direction For example, as shown clearly in FIG. 3, the illustrated milling drum 100 includes a first section 132 of flighting 130 that winds in one direction and a second section of winding 134 that winds in the opposite direction. As a result, the two sections of flighting 132, 134 both urge the removed material laterally toward the center of the milling drum 100 as the milling drum turns, where the removed material can be transported away from the roadway by a conveyor.

In the illustrated example, the length of the first section of flighting 132 is equal to the length of the second section of flighting 134. Accordingly, the two sections of flighting 132, 134 each support the same number of milling tools 150. This helps ensure that the lateral force on the milling drum 100 overall is substantially uniform. To further help balance the lateral load on the drum, in this illustrated embodiment, the rolling milling tools 152, which are explained in more detail below, are arranged to all face toward the axial center of the milling drum 100. Accordingly, the rolling milling tools 152 arranged on the first section of flighting 132 face one direction while the rolling milling tools 152 arranged on the second section of flighting 134 face the opposite direction. Because the rolling milling tools 152 are all arranged to face the center of the milling drum 100, the rolling milling tools 152 themselves impart lateral movement of the removed material toward the center of the milling drum 100, where it can be conveyed efficiently. By extension, the rolling milling tools 152 form a helix off of the helix formed by the flighting, as shown in FIG. 3, and thus also convey the removed material.

While the illustrated milling drum 100 includes two sections of flighting of equal length, in some embodiments, the sections of flighting may be of different lengths. Further, in some embodiments, the milling drum may include multiple sections of flighting that change directions along the length of the drum.

In some embodiments, the first section of flighting includes at least two interleaved helixes. The interleaved helixes of flighting can improve material handling efficiency by increasing the volume of material moved laterally per revolution. By staggering the helical flighting, the milling drum can reduce empty space between flights, leading to a more continuous and even flow of material. This may be useful for preventing the cuttings and removed material from compacting or clogging. Alternatively, in some embodiments, the flighting may include a single helix that extends around the drum.

In some embodiments, the flighting includes a helix that extends continuously around the drum body at least 180 degrees. For example, in the illustrated milling drum 100, as shown in FIG. 3, each flighting section 132, 134 includes three flights that extend continuously for about one full circumference of the drum body 110. In other embodiments, each flight may extend further, such as one and a half, two, or more rotations around the drum body.

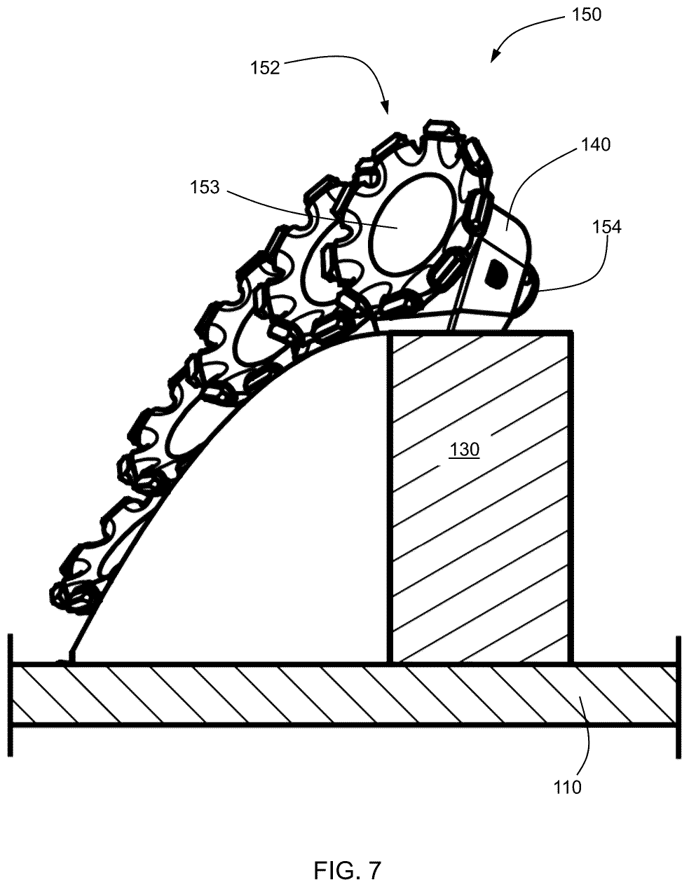

FIG. 7 shows a cross-sectional side view of one segment of flighting 130. As shown, the flighting 130 is secured to the drum body 110 and a milling tool mount 140 is attached to the outer periphery of the flighting 130. A milling tool 150 is secured in the milling tool mount 140. In this image, the milling tool 150 is a rolling milling tool 152, which operates to cut the material, as explained in more detail below. However, in other embodiments, the milling tool may be a pick, such as a carbide pick.

In some embodiments, the thickness of the helicoid flighting at its outer periphery is at least 2 inches. As shown in FIG. 7, in the illustrated embodiment, the flighting 130 has a uniform thickness from the surface of the drum body 110 to the outer periphery. In other embodiments, the flighting may taper toward the outer periphery. However, the flighting should have a sufficient thickness to hold the milling tool mounts. In some embodiments, the thickness of the flighting at the outer periphery may be in a range of 2 to 6 inches, such as 2.5 to 4 inches.

As shown with respect to the milling tool mount 140 disposed on the flighting 130 in FIG. 7, each rolling milling tool 152 may have a front side 153 and a shaft 154 extending from the back side of the rolling milling tool 152. The rolling milling tool 152 may be coupled to the milling tool mount 140 by the insertion of the shaft 154 through the milling tool mount 140. The connection between the shaft 154 and milling tool mount 140 may provide a freewheeling connection so that the rolling milling tool 152 is free to rotate within milling tool mount 140, as explained further below. A pin or other fastener may be used to hold the rolling milling tool 152 in place within the milling tool mount 140. In some embodiments, the rolling milling tool 152 may include teeth around the circumference of the front side 153 of the rolling milling tool 152. Further, in some embodiments, the teeth may include carbide tips. For example, the rolling milling tools may include carbide inserts that are held in receptacles around the circumference of the rolling milling tool. Such carbide inserts may form the teeth of the rolling milling tool.

As shown in FIG. 4, the rolling milling tools 150 may extend around the circumferential outer surface 120 of cylindrical body 110. Accordingly, as the milling drum 100 is rotated, a sequence of rolling milling tools may come into contact with the surface being milled so as to remove material throughout the rotation of the milling drum 100.

The milling drum may also include a plurality of carbide picks 160 secured to the circumferential outer surface 120 of the cylindrical drum body 110. Each of the carbide picks 160 may have a fixed position relative to the circumferential outer surface 120 of the cylindrical body 110. Thus, while the milling drum 100 rotates, the carbide picks 160 will move in concert with the circumferential outer surface 120 of the drum body 110 of the milling drum 100. The carbide picks 160 may have various forms and shapes.

FIG. 4 shows an end view of the milling drum 100. As illustrated in FIG. 4, the carbide picks 160 are placed at three evenly spaced positions on the circumferential outer surface 120 of the drum body in association with each helix of flighting. Alternatively, in other embodiments, the rotary picks may be positioned at regular intervals around the entire circumferential surface, such as every 90 degrees, every 60 degrees, every 45 degrees, every 30 degrees or another interval. Alternatively, the carbide picks may be provided at irregular intervals, or the carbide picks may be concentrated within one angle range around the milling drum. Further still, carbide picks can be used throughout the milling drum in other embodiments.

Positioning the carbide picks at the ends of the drum body allows the carbide picks to be used to produce the outer side of the cut profile in the material being profiled. The carbide picks can be made smaller and positioned very precisely, which can allow the carbide picks to form a desired shape at the sides of the profile. The carbide picks can also be placed in front of rolling milling tools along the line of action of the rolling milling tools, such that the carbide picks protect portions of the rolling milling tools or their respective milling tool mounts.

The total number of milling tools used in the illustrated milling drum is only illustrative. The number of milling tools, including rolling milling tools and carbide picks can be varied as required for a particular application or the characteristics of the earthen material being profiled. For example, where the milling drum is intended to be used on extremely hard materials, the milling drum may be configured to include a greater number of rolling milling tools and/or carbide picks compared to a milling drum designed to profile softer materials.

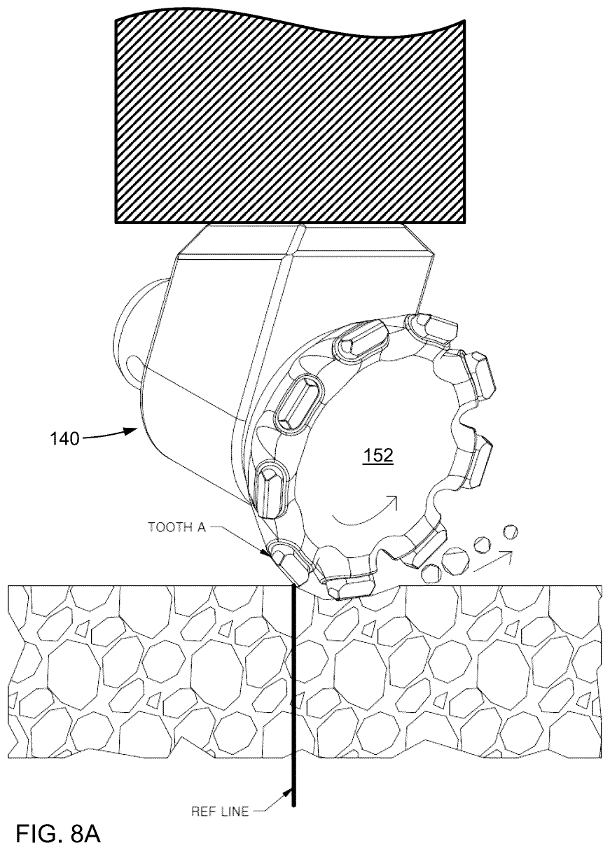

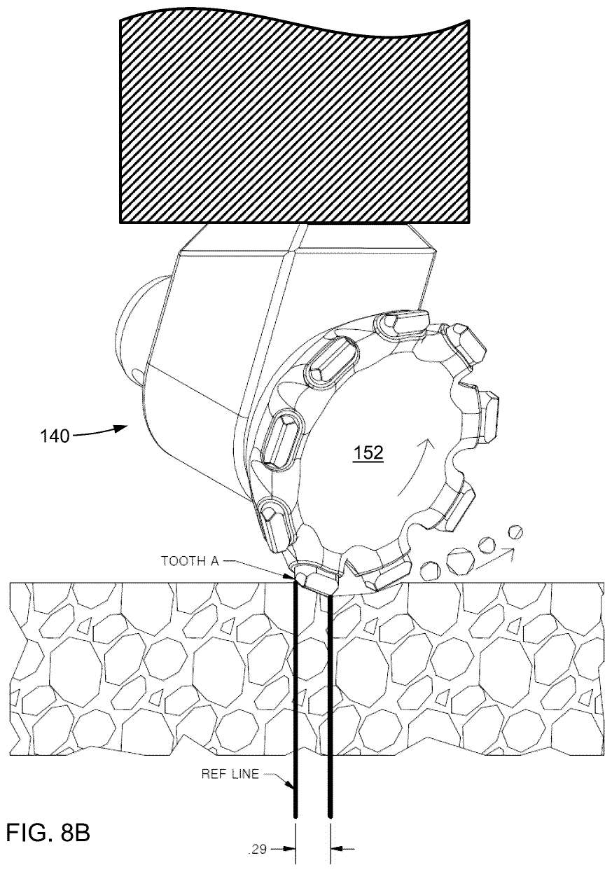

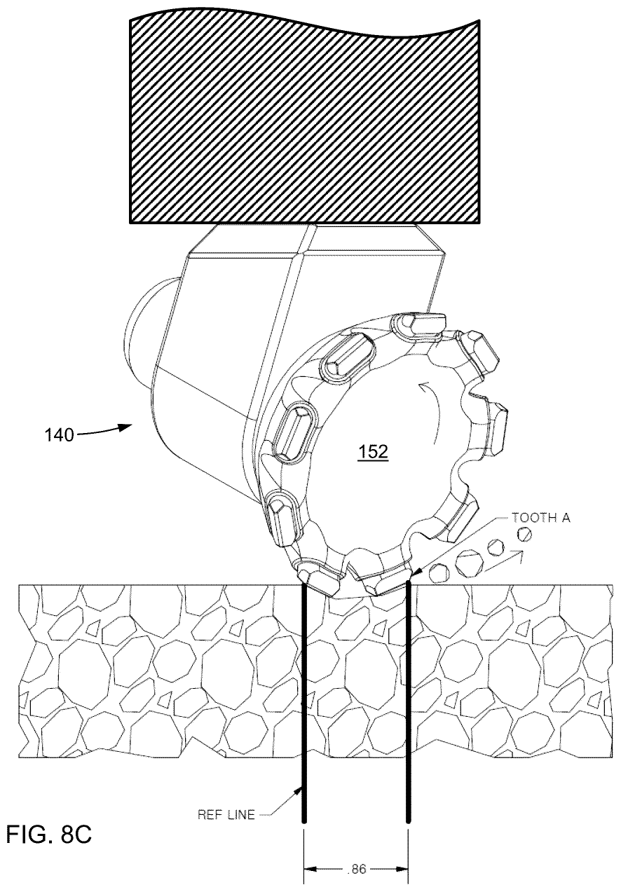

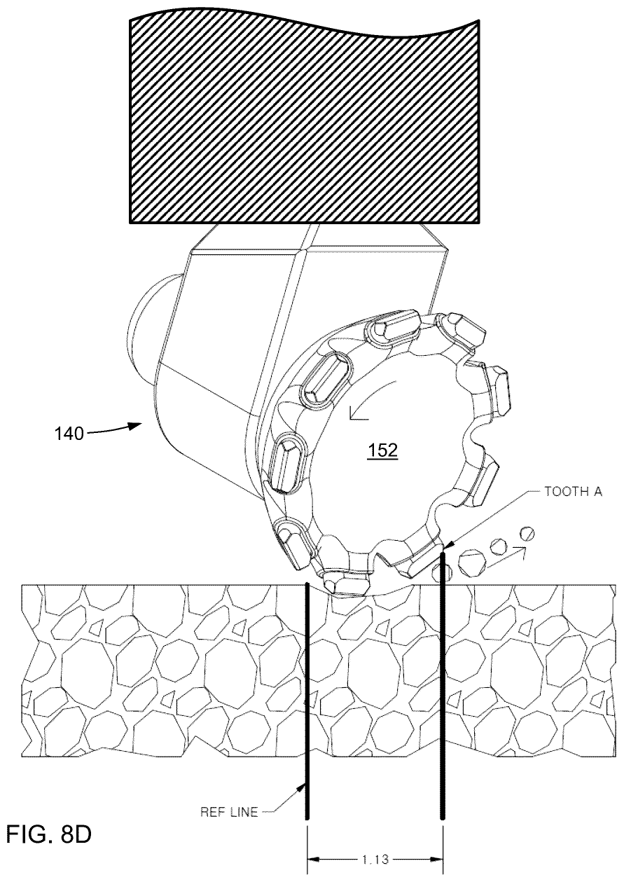

FIG. 8A through 8D illustrate an embodiment of a rolling milling tool 152 as it moves with the rotation of the milling drum 100. The views of FIGS. 8A through 8D represent successive rotation of the rolling milling tool 152 as the rotating milling drum 100 moves the rolling milling tool 152 in a direction moving toward the viewer, in other words out of the page.

A key difference between the rolling milling tools 150 shown in FIGS. 8A-8D and carbide picks is that the rolling milling tool 152 pulls and separates the material being profiled while carbide picks crush the material. In particular, carbide picks work with brute force crushing the material. In contrast, the rolling milling tools 150 work by rolling against the material being profiled and, in the process, separating the material in a tensive mode. In other words, it is a difference between pulling and crushing the material.

To accomplish the end result, at least some of the rolling milling tools may be canted by two angles, such that the rolling milling tools are canted with respect to the surface being profiled. For example, in some embodiments, the rolling milling tools include a group of rolling milling tools that are canted at a side angle such that the front side of the rolling milling tool faces a tangential direction of the cylindrical body so as to face a line of action of the rolling milling tool as the milling drum is rotated. Likewise, in some embodiments, this group of rolling milling tools may be canted at a tilt angle such that the front side of the rolling milling tool faces away from the circumferential outer surface of the cylindrical body. On the other hand, some of the rolling milling tools of the milling drum may be canted at different angles. For example, some of the rolling milling tools may have angles configured to target certain locations of the cut profile, such as the sides, or may have particular angles in view of geometric constraints.

Turning to FIGS. 8A through 8D, these figures describe the successive action of one particular tooth “A” of several teeth on a rolling milling tool 152 as the milling tool mount 140 that carries the rolling milling tool 152 is effectively moved forward by the rotation of the milling drum 100 and is illustrated as if being pulled outward from the page.

As the milling tool mount 140 carrying the rolling milling tool 152 moves with rotation of the drum, because of the friction between the rolling milling tool 152 and the surface being profiled, tooth “A” back rolls over the surface being profiled. As this rolling milling tool 152 with tooth “A” rolls backward, tooth “A” simultaneously moves laterally or sideways and perpendicular to the forward movement of the milling tool mount 140. Likewise, as tooth “A” moves laterally it also moves vertically into the surface of the material. As tooth “A” both moves laterally and vertically, and freely back rolls relative to the rotation of the milling drum, tooth “A”, being predisposed by the cant angles, is likewise predisposed to the material being profiled.

Tooth “A” is then driven slightly into the surface being profiled. As the milling tool mount 140 carrying the rolling milling tool 152 continues moving with rotation of the drum, tooth “A” is both further driven laterally into the material being profiled while at the same time tooth “A” begins to rotate upward away from the material being profiled, thereby putting the material being cut in tension and breaking the material's bond. As the milling tool mount 140 carrying the rolling milling tool 152 further rotates with the milling drum 100, each successive tooth on the rolling milling tool 152 after tooth A may repeat the cutting and pulling action demonstrated by tooth A.

FIG. 8A illustrates a position where tooth “A” of rolling milling tool 152 initially makes contact with the surface of the material being profiled. The point or location of tooth “A” where tooth “A” makes initial surface contact with the material being profiled is referred to in FIGS. 8A-8D as a “reference” line.

FIG. 8B illustrates the position of tooth “A” as the milling drum continues to rotate and move the milling tool mount 140 that holds rolling milling tool 152. In FIG. 8B, tooth “A” is fully engaged with the material being profiled. As tooth “A” rotates, it also moves laterally and downward with respect to the material being profiled and the centerline axis of the milling drum, in view of the rotation of the rolling milling tool 152 with respect to the cylindrical body 110 of the milling drum 100. The amount of tooth “A's” lateral and downward movement between FIG. 8A and FIG. 8B is illustrated by the second vertical line to the right of the original reference line.

FIG. 8C illustrates the position of tooth “A” as the milling drum continues to rotate further and move the milling tool mount 140 that holds rolling milling tool 152. Tooth “A” now begins to rotate out of the material being profiled. As tooth “A” has rotated, tooth “A” has also moved laterally and upward further from the centerline axis of the cylindrical body 110 and has begun to move vertically away from the material being profiled. As the combined lateral and vertical movement of tooth “A” is exerted on the material being profiled, some of the material is pulled away from the surface. The amount of lateral movement of tooth “A” is illustrated by the second vertical line further to the right of the original reference line. The amount of vertical tooth movement from beginning to end as tooth “A” rotates is illustrated by the distance from the top of the surface being profiled to the lowest point at which tooth “A” is from this top surface.

FIG. 8D illustrates the position of tooth “A” as the milling drum continues to rotate even further and move the tool mount 140 that holds the rolling milling tool 152. Tooth “A” has now moved above the surface being profiled and no longer engages this surface. At this point subsequent teeth following tooth “A” around the circumference of the rolling milling tool 152 that is carried by the milling tool mount 140 and milling drum follow tooth “A” successively and continuously repeat the surface engaging and disengaging process of the teeth that is illustrated in FIGS. 8A through 8D with respect to tooth “A”.

In summary, as the rolling milling tool of the disclosure rolls over a material being cut, due to the attack angle of the rolling milling tool teeth which are predisposed towards the surface of the material being profiled, as the rolling milling tool rolls at an angle to the forward movement of the rolling milling tool through the material being profiled, the teeth of the rolling milling tool are presupposed laterally to the forward line of action of the rolling milling tool. As a result, the teeth slightly grip the material being rolled over and profiled and the teeth of the rolling milling tool then lift the material up and away from the surface that the rolling milling tool is engaging. This tooth lifting action takes the form of a wedge and rolls apart the material being profiled.

As used herein, unless otherwise indicated herein, the terms “first,” “second,” etc. are used merely as labels. These identifiers are not intended to impose hierarchical, ordinal, or positional requirements on the items to which these terms refer. Moreover, reference to a “first” feature or item does not require the existence of a “second” or higher-numbered item.

Unless otherwise indicated herein, the term “or” is inclusive. For example, a description of a device as including a first component or a second component should be understood to include devices including the first component without the second component, devices including the second component without the first component, and devices including both the first component and the second component.

As used herein, the description of a system, apparatus, device, structure, article, element, component, or hardware as being “configured to” perform a specified function is indeed capable of performing the specified function without any alteration, rather than merely having potential to perform the specified function after further modification. In other words, the system, apparatus, structure, article, element, component, or hardware “configured to” perform the specified function is specifically selected, created, implemented, utilized, programmed, and/or designed for the purpose of performing the specified function. Further, as used herein, the term “configured to” denotes existing characteristics of the system, apparatus, structure, article, element, component, or hardware which enable the system, apparatus, structure, article, element, component, or hardware to perform the specified function without further modification.

While various aspects and embodiments have been disclosed herein, it will be apparent to those skilled in the art that various modifications and variations may be made to the devices and methods described here without departing from the scope of the disclosure. Accordingly, the present disclosure is intended to cover such modifications and variations of the disclosure, with the scope of the disclosure being set forth by the appended claims and their equivalents.

1. A milling drum for milling a working surface, the milling drum comprising:
a drum body extending along an axis from a first end to a second end, the body including an outer surface encircling the axis;
helicoid flighting secured around the outer surface of the drum body, the helicoid flighting including an inner side attached to the drum body and an outer periphery; and
a plurality of milling tool mounts secured on the outer periphery of the helicoid flighting.

2. The milling drum according to claim 1, wherein the helicoid flighting includes a first section that winds around the drum body in a first direction, and a second section that winds around the drum body in a second direction.

3. The milling drum according to claim 2, wherein the first section is positioned toward one end of the drum body and the second section is positioned toward an opposite end of the drum body.

4. The milling drum according to claim 2, wherein the first section of flighting includes a helix that extends continuously around the drum body at least 180 degrees.

5. The milling drum according to claim 2, wherein the first section of flighting includes at least two interleaved helices.

6. The milling drum according to claim 5, wherein milling tool mounts secured to a first of the interleaved helices is angled in a first direction and milling tool mounts secured to a second of the interleaved helices is angled in a second direction.

7. The milling drum according to claim 1, wherein the outer periphery of the helicoid flighting has a thickness of at least 2 inches.

8. The milling drum according to claim 1, further comprising a milling tool secured in each milling tool mount.

9. The milling drum according to claim 8, wherein at least a portion of the milling tools are rolling milling tools.

10. The milling drum according to claim 9, wherein each rolling milling tool includes a front side and teeth disposed around a circumference of the front side.

11. The milling drum according to claim 10, wherein each rolling milling tool is canted at a side angle such that the front side of the rolling milling tool faces a tangential direction of the drum body so as to face a line of action of the rolling milling tool as the milling drum is rotated.

12. The milling drum according to claim 10, wherein a first group of the rolling milling tools are canted at a first side angle such that the front side of the rolling milling tool faces a first end of the milling drum, and wherein a second group of rolling milling tools are canted at a second side angle such that the front side of the rolling milling tool faces a second end of the milling drum.

13. The milling drum according to claim 10, wherein each rolling milling tool is canted at a tilt angle such that the front side of the rolling milling tool faces away from the circumferential outer surface of the drum body.

14. The milling drum according to claim 10, wherein the teeth of each rolling milling tool are configured to follow a circular path with respect to the circumferential outer surface of the drum body.

15. The milling drum according to claim 9, wherein a back side of each rolling milling tool includes a shaft that is rotatably held in one of the milling tool mounts so as to form a freewheeling connection between the rolling milling tool and the respective milling tool mount.

16. A surface milling machine comprising:
a vehicle propulsion system; and
a milling drum comprising:
a drum body extending along an axis from a first end to a second end, the body including an outer surface encircling the axis;
helicoid flighting secured around the outer surface of the drum body, the helicoid flighting including an inner side attached to the drum body and an outer periphery;
a plurality of milling tool mounts secured on the outer periphery of the helicoid flighting; and
a milling tool coupled to each milling tool mount.

17. The surface milling machine according to claim 16, wherein the helicoid flighting includes a first section that winds around the drum body in a first direction, and a second section that winds around the drum body in a second direction.

18. The surface milling machine according to claim 17, wherein the first section is positioned toward one end of the drum body and the second section is positioned toward an opposite end of the drum body.

19. The surface milling machine according to claim 17, wherein the first section of flighting includes a helix that extends continuously around the drum body at least 180 degrees.

20. The milling drum according to claim 17, wherein the first section of flighting includes at least two interleaved helices.
